(19) United States
(12) Patent Application Publication
(10) Pub. No.: US 2020/0019982 A1
(43) Pub. Date: Jan. 16, 2020

(54) SYSTEM AND METHOD FOR MARKETING INCENTIVE OFFERS VIA THE INTERNET OF THINGS

(71) Applicant: SVM, LP, Arlington Heights, IL (US)

(72) Inventor: Tan Nhat Truong, Houston, TX (US)

(73) Assignee: SVM, LP, Arlington Heights, IL (US)

(21) Appl. No.: 16/032,586

(22) Filed: Jul. 11, 2018

(51) Int. Cl. G06Q 30/02; G06F 3/16

(52) U.S. Cl. CPC G06Q 30/0239; G06F 3/167; G06Q 30/0224

(57) ABSTRACT

A system and methods for marketing incentive offers via the Internet of Things (“IoT”). The system may comprise: at least one gateway component, a marketing module, input interfaces, a control center, and a data warehouse. The gateway component may be configured to receive and transmit data from a smart product, or product manufacturer. The marketing module may analyze smart product usage, and retail offers; it also may employ data analytics and machine learning to generate customized incentive offers for a product user. The data warehouse may be configured to store data, while the interfaces and control center may relay information through the system. The system may process data associated with a product user's demands and behavior patterns, to formulate a targeted marketing strategy. Methods for system use are also described. Overall, the present invention utilizes data generated by smart-products or other IoT-enabled products to create custom product user incentive offers.

### BACKGROUND OF THE INVENTION

The present invention relates generally to systems and methods for marketing products and services. More specifically, the present invention relates to systems and methods for marketing incentive offers via the Internet of Things (“IoT”). The arrival and subsequent explosive growth of the IoT has significantly improved the product user experience by enabling direct interactions with smart products, such as, for example, refrigerators or thermostats. The modern product user experience has been further enriched by voice assistants such as Alexa® by Amazon®, Google Home® by Google®, Siri® by Apple®, and Bixby® by Samsung®. For example, it is now common for product users to adjust the temperature in their homes, arm or disarm their alarm systems, play a song on their playlists, or interact with their automobiles through a voice interactive system. Consequently, product user engagement with smart products has set the stage for untapped and novel ways to market incentive offers. With the rise of the IoT, manufacturers have been given an unprecedented opportunity to utilize their smart products to tailor these incentive offers to their product users. Accordingly, there is a need for new types of systems and methods for marketing IoT offers as described herein.

### BRIEF SUMMARY OF THE INVENTION

To meet the needs described above and others, the present invention provides a system for enhancing products relating to the IoT. The general purpose of the invention is to enrich product user interaction with smart products by tailoring personalized incentive offers to a particular user. These incentive offers may include promotional products including, but not limited to, gift cards, sales and gift codes.

In a preferred embodiment, the system may include a specialized data processing service (“SDPS”) IoT gateway that receives smart product data from at least one manufacturer and a marketing processor which generates an incentive offer. In one embodiment, the marketing processor may utilize data collected in a data warehouse, as well as data analytics and retail offers to create custom tailored offers to a product user.

The system of the present invention utilizes smart products' abilities to share data; most IoT smart products are programmed to automatically share their data with their respective manufacturers. The data from the manufacturers may contain insights into the product's usage details as well as insights into a product user's preferences, based on his or her usage of the smart product, Moreover, details about the product, including but not limited to, if a replacement part is needed, or if the product needs maintenance, may be gleaned from the smart product's shared data.

The system harnesses the power of the smart products' data sharing capabilities in order to create a personalized incentive offer tailored to the smart product's user. At least one embodiment of the system uses an algorithm to analyze and learn from data points generated by the product user's behavior and collected by the smart product. In one embodiment, once a manufacturer shares its data with the system, the system processes the data using a marketing module, effectively cleaning, normalizing, structuring, and enriching the data. The processed data is then used to create the incentive offer. For example, an incentive offer may be created by cross-referencing the processed smart product data with data from retailers regarding sales and promotions. The system may take data from smart products, integrate it with data about sales, promotions and retail offers, and use the combined data to make a real-time, custom-tailored incentive offer to a product user. The processed smart product data may be matched with promotions and relayed back to the manufacturer and/or the product user for evaluation. For example, if a smart product communicates that a part is broken or malfunctioning, the system may scan its database of retail offers for a deal on that part. After finding an applicable retail offer, the system may process the retail offer and send an incentive offer directly to the product user. After the product user accepts or rejects the incentive offer, the system learns the product user's preferences and may tailor a future incentive offer to accommodate the product user. Each time a product user interacts with the product, the system learns based on these interactions and improves its subsequent offers/promotions. Moreover, data collected throughout the process may be stored in the system's data warehouse so that it may be accessed for future use.

Additional objects, advantages and novel features of the examples will be set forth in the description which follows and will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims and known to those skilled in the art.

### BRIEF DESCRIPTION OF THE DRAWINGS

Additional objects and features of the invention will be more readily apparent from the following detailed description and appended claims when taken in conjunction with the Figures, in which:

FIG. 1 is a schematic diagram of an embodiment of the system, showing a transfer of data from at least one smart product through generation of at least one incentive offer.

FIG. 2 is a schematic diagram of an embodiment of the system, showing a product user's command being processed through the system.

FIG. 3 is a schematic diagram of an embodiment of the system, showing a transfer of data from an SDPS gateway to a data warehouse.

FIG. 4 is a schematic diagram of an embodiment of the system, showing a transfer of data to and from a marketing module.

### DETAILED DESCRIPTION OF THE INVENTION

Although the present disclosure is described with reference to specific exemplary embodiments, it will be evident that various modifications and alterations may be made to these embodiments without departing from the broader scope and essence of the disclosure. Accordingly, the specification and drawings are to be regarded in an illustrative rather than a restrictive manner.

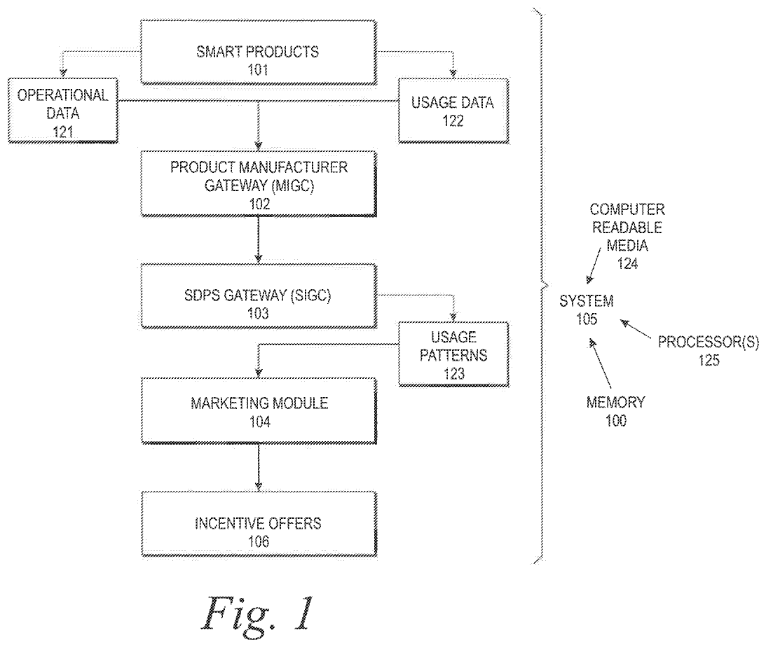

FIG. 1 illustrates an embodiment of the system 105 and shows how data may flow within the system 105. First, smart products 101, which are IoT enabled, may transmit operational data 121 to at least one product manufacturer's IoT gateway component (“MIGC”) 102. As used herein, a smart product 101 may include any smart product, including but not limited to, smart-refrigerators, smart TVs, smart air conditioners, or any other IoT enabled product, Data snared by the manufacturer may include, but is not limited to, operational data 121 which indicates basic details of the smart product's 101 specifications, make and model. The operational data 121 of the smart product 101 may also describe the current operating status of its parts, and may alert a product user 107 to any necessary service requirements and/or part replacements. Usage data 122 is data that reveals how the smart product 101 is being utilized by a product user 107, including but not limited to the smart product's 101 settings and configurations. For instance, usage data 122 may indicate the preferred temperature set by a product user for his or her smart thermostat or the preferred freezer setting for his or her smart refrigerator.

The MIGC 102 is a manufacturer's component preferably integrated with the smart product 101. The MIGC 102 may be configured to receive, transmit, and store data sent from at least one smart product 101 to at least one manufacturer. After receiving the data in the MIGC 102, the product manufacturers may share the smart product 101 data with an SOPS gateway component (“SIGC”) 103. The SIGC 103 is a component that may be configured to receive, store, process and transmit data. Like all other components discussed herein, the SIGC 103 may be comprised of software, hardware, firmware, or any combination thereof Product data from the MIGC 102 may be in its original format. Accordingly, in this embodiment, manufacturers do not have to process the data before sharing it with the SIGC 103.

After receipt by the SIGC 103, the system 105 may validate and clean the unprocessed data. The data cleaning step (“data cleaning”) 113 is the process by which the system 105 removes any data points that are not integral for generating personalized and targeted incentive offers 106 to a product user 107.

After the input data is cleaned by the SIGC 103, it may be forwarded to a marketing module component (“marketing module”) 104. The marketing module 104 is a component that may be configured to perform at least three tasks: (1) the data normalization step (“data normalization”) 115; (2) the data structuring step (“data structuring”) 116; and (3) the data enrichment step (“data enrichment”) 117. Data normalization 115 is a process that allows the system 105 to standardize the input from the SIGC 103 to create a more uniform and easy to understand data set. When the manufacturer's data points are compiled and filtered using the MIGC 102 and SIGC 103, data points may be obtained from different suppliers and thus may be expressed differently. For example, one smart product may come from a supplier based in Europe so its data may be expressed in Metric System units, while another product may come from the United States and use the U.S. Standard System. In a preferred embodiment, the data normalization 115 process is performed by the marketing module 104, and may create a more unified set of data by eliminating differences between data sets. For example, in one embodiment the marketing module 104 uses tools, including but not limited to, a conversion table with instructions on how to convert Celsius to Fahrenheit to standardize units for temperature.

In addition to using data normalization 115, the marketing module 104 also may be configured to structure the data using data structuring 116. Data structuring 116 is a process that organizes the data into defined data sets. Although in the preferred embodiment, data structuring 116 occurs after the data has been cleaned 113 and normalized 115, it may occur at a different time if necessary. Implementing data structuring 116 of the preferred embodiment, the system 105 is configured to organize data into subgroups. For example, the system 105 may be configured to transfer all data relating to maintenance into a maintenance category. Other categories, including but not limited to, a replacement parts category or a user preferences category, may also be used to structure the data. Because data structuring 116 provides the system 105 with an organized framework to analyze the data, it assists the system 105 in better understanding the data transmitted to the marketing module 104 from the SIGC 103.

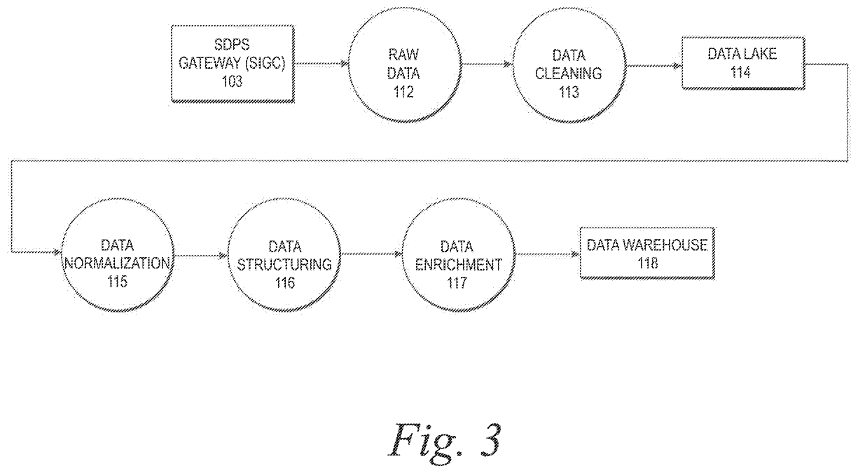

A third process that the marketing module 104 may perform is data enrichment 117. Data enrichment 117 is a step that adds additional data attributes to the manufacturer's data in order to create an optimal incentive offer 106 for a product user 107. These additional data attributes are defined in the data warehouse component 118 which is powered by a database management system including but not limited to a Microsoft® SQL Server. During the process of data enrichment 117, each row of manufacturer's data is populated with these additional data attributes and then subsequently stored in the data warehouse 118. Data enrichment 117 may take place after the data is cleaned 113, normalized 115 and structured 116. For example, if a filter on a refrigerator needs to be replaced, data enrichment 117 may provide information about the last time a filter was replaced. In an embodiment, the data utilized in the data enrichment step 117 is stored in the data warehouse component 118. Data enrichment 117 may expand the system's 105 existing database and integrate insights about a product user's 107 preferences, activities and other proclivities into the existing knowledge it has from the manufacturer. Moreover, a product user's 107 interaction with the smart product 101 may enhance the system's 105 ability to learn and may generate machine learning which yields the enrichment 117 step. The data cleaning 113, data normalization 115, data structuring 116 and data enrichment 117 steps are further illustrated in FIG. 3.

The system 105 may include one or more processors 125. The processor(s) 125 of the system 105 execute one or more steps to cause the system 105 to perform a variety of functions, as set forth herein. In various embodiments, the processor(s) 125 of the system 105 may comprise a central processing unit (“CPU”), a graphics processing unit (“GPU”), both a CPU and GPU, or other processing units or components known in the art. For instance, the processor(s) 125 may allow the system 105 to perform any action that allows the marketing module 104 to identify usage patterns 123 associated with the smart product 101. Furthermore, each component of the system 105 may possess its own local memory 100, which also may store program modules, data and/or one or more operating systems.

In an embodiment, the system 105 may include computer readable media 124. The computer readable media 124 of the system 105 may include any components that may be used to transmit data to the system 105, including but not limited to, operational data 121 and usage data 122. Depending on the exact configuration and type of smart product 101, the computer-readable media 124 may include memory 100. Memory 100 may comprise any type of memory, including volatile memory (for example, RAM), non-volatile memory (for example, ROM), flash memory, miniature hard drive, memory card, or any combination thereof.

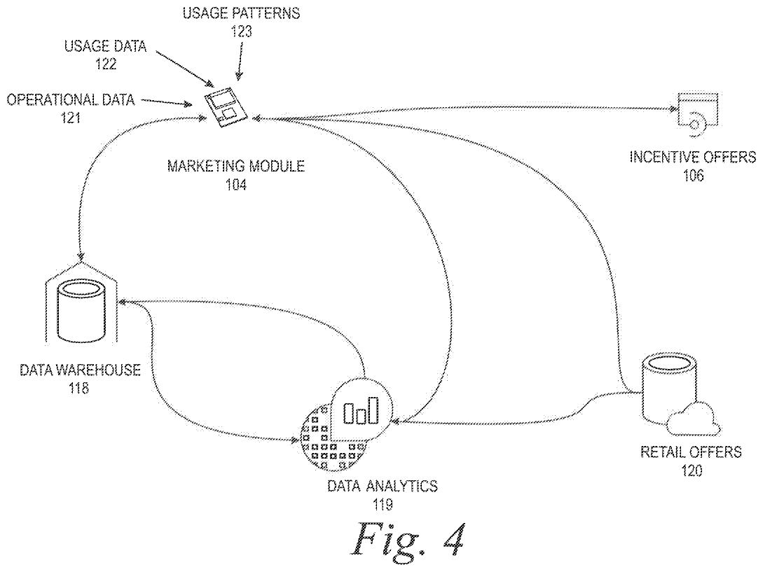

As shown in FIG. 4, after the data is processed by the marketing module 104, the system 105 generates an SDPS incentive offer (“incentive offer”) 106. The incentive offer 106 comprises at least one retail offer 120 that the system 105 tailors to the particular product user 107. To generate the incentive offer 106, the marketing module 104 may cross reference operational data 121, usage data 122 and usage patterns 123 with at least one applicable retail offer 120. For example, the system 105 may match a replacement part sale with a product user 107 who needs such a replacement part. The system's 105 evaluation results in at least one personalized incentive offer 106. The incentive offer 106 may then be presented to product manufacturers and, in turn, the manufacturers may present the incentive offer 106 to the product user 107. The incentive offer 106 may also be presented to the product user 107 directly via the smart product's 101 interface or by any appropriate delivery method, including but not limited to email or post mail.

In an embodiment of the invention, the smart product 101 includes a display, speaker, and other appropriate input and output devices to communicate the incentive offer 106 to the product user 107, The smart product 101 may also include elements that allow the product user 107 to communicate with the smart product 101, including hut not limited to, a voice input device and a tactile input device. The product user 107 may utilize the smart product's 101 features to interact with the smart product 101, and accept or reject incentive offers 106. The display of the smart product 101 may include any type of display known in the art that is configured to present and/or display information to the product user 107. For instance, the display may be a screen or graphical user interface that allows the product user 107 to indicate whether the user 107 accepts or rejects the incentive offer(s) 106.

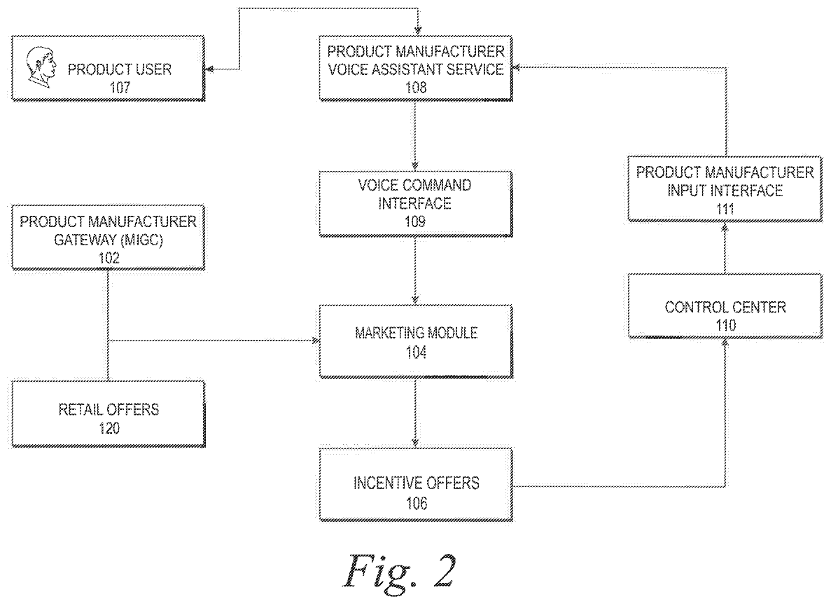

As illustrated in FIG. 2, it a preferred embodiment, the system 105 may actively involve the product user 107. For example, the product user 107 first interacts with the manufacturer voice assistant service component (“manufacturer voice assistant service”) 108. The manufacturer voice assistant service 108 is a component that the smart product 101 manufacturer may choose and configure to process a product user's 107 voice command. The manufacturer voice assistant service 108 may be a voice recognition program or any other appropriate program known to persons skilled in the art. The manufacturer voice assistant service 108 may be configured to relay the product user's 107 voice command to the SDPS voice command interface component (“voice command interface”) 109. The voice command interface 109 is a component that may be configured to receive the command sent from the manufacturer voice assistant service 108 and then forward it to the marketing module 104. As illustrated in FIG. 1, the marketing module 104 may process the data to create the incentive offer 106.

FIG. 2 illustrates how an embodiment of the system 105 may forward data after generating an incentive offer 106. Specifically, FIG. 2 shows how the system 105 may be configured to forward the incentive offer 106 to the SDPS control center component (“control center”) 110. The control center 110 is a component that formulates a set of offer options, generated based on the product user's 107 prior actions and prior preferences. The control center 110 is also configured to operate as a communications mechanism between the system 105 and at least one manufacturer. If the manufacturer and/or the smart product 101 require a particular format for data, the control center 110 may be configured to convert the data comprising the incentive offer 106 into a format that the manufacturer of the smart product 101 will understand. In an embodiment, after the control center 110 converts the incentive offer 106 to an understandable format, it may be presented to the product user 107 for acceptance, rejection, or a counter offer. The incentive offer 106 may be evaluated and optimized based on options contained within the control center 110. Specifically, the control center 110 may comprise a predefined set of rules for converting the format of incentive offers 106 from SDPS standards to a manufacturer's defined format and metrics. When the control center 110 receives an incentive offer 106, it may transform the data into a target manufacturer's language. For example, if a target manufacturer is located in Canada and accepts Canadian dollars, and the incentive offer 106 is provided in United States dollars, the control center 110 identifies this discrepancy and converts the offer into Canadian dollars. The control center 110 may then forward the converted offer to the Canadian manufacturer. In an embodiment, the control center 110 is configured to receive the incentive offer 106 generated by the marketing module 104 and transmit the incentive offer 106 directly to the product user 107.

Once processed by the control center 110, the system may be configured to forward the incentive offer 106 to a product manufacturer input interface component (“product manufacturer input interface”) 111. The product manufacturer input interface 111 is a component that may be configured to forward the incentive offer 106 to the manufacturer's voice assistant service 108. The product manufacturer input interface 111 may be configured to receive the incentive offer 106 as text and convert it from text to speech before relaying the converted incentive offer 106 to the manufacturer voice assistant service component 108. The manufacturer voice assistant service 108 may be configured to then relay the speech incentive offer 106 to the product user 107. This step completes a cycle which commences with a product user's 107 voice command and ends with the product user 107 receiving an incentive offer 106 from the manufacturer's voice assistant service 108.

FIG. 2 illustrates how, in one embodiment of the system 105, data from the MIGC 102 may be combined with data about at least one retail offer 120 (“RO”). This combined data may be forwarded into the marketing module 104 where it is analyzed as shown in FIG. 1 and FIG. 4. In an embodiment, the marketing module 104 processes a set of self-learning algorithms which identify specific product user 107 usage patterns 123. For example, the patterns 123 may show product user 107 usage of at least one smart product 101. The product usage patterns 123 may include, but are not limited to, how often the smart product 101 is used and when the smart product 101 is used. These algorithms, described above, may be designed to organize product user 107 usage patterns 123 into a data structure that enables continuous learning and may yield incentive offers 106. The marketing module 104 may also determine if these product user 107 usage patterns can be associated with any available ROs 120. The data that the marketing module 104 analyzes may then be matched with available and applicable ROs 120 to produce incentive offers 106 that are personalized to the product user 107. The matching may be performed by cross referencing data about the product user 107 with available ROs 120. This data may comprise operational data 121, usage data 122 and usage patterns 123. The cross referencing may utilize a cross reference table to sort and match the data.

FIG. 3 illustrates the flow of data from the SDPS gateway component (“SIGC”) 103 to a data warehouse 118. As discussed in connection with FIG. 1, the SIGC 103 is a component that may be configured to receive, hold, process and transmit data. The data received by the SIGC 103 may be the unfiltered original data received from the smart product 101 manufacturers, referred to herein as raw data 112. The raw data 112 may then be cleaned by the system 105 in the data cleaning process. Particularly, during the data cleaning 113 process, raw data 112 may be scanned for unrelated data points which are not useful to the system 105 and the unrelated data points may be removed. In an embodiment, a parameter may indicate a variable that describes an attribute of operational data 121 and usage data 122 shared by at least one smart product 101. For example, if the smart product 101 is a smart refrigerator, it may share its current operating temperature which appears as parameters in a dataset.

In some instances, raw data 112 may be flawed. Particularly, raw data 112 may contain parameters which are duplicated in the data set, values for such parameters may be missing, or parameters may not be relevant to the system 105. For example, raw data 112 may contain parameters such as communication protocol used for transfer of data between smart products 101 and their associated manufacturers. However, such parameters may not be useful to transmit to the marketing module 104 for processing the incentive offers 106, and thus may be removed from the dataset. In another example, raw data 112 may contain parameters with invalid values, Le., a timestamp parameter in a data set may contain ‘xxx-xxx’ as a value, which cannot be translated to a valid timestamp. In data cleaning 113, parameters with invalid and inconsistent values are removed from the dataset. Moreover, in another example, some parameters in the dataset may indicate missing values, or other parameters may appear multiple times in the same dataset. The parameters with missing values may be removed and duplicate parameters may also be removed, such that a parameter only appears once in a dataset. Overall, through data cleaning 113, the system 105 cleans incoming operational data 121 and usage data 122 to produce a clean dataset with accurate and germane parameter values. The data cleaning 113 process may also utilize the pre-set parameters of the marketing module 104 to deliver at least one targeted and personalized incentive offer 106.

After the data is cleaned, it may be stored in an SDPS data lake 114 component (“data lake”) which is powered by a database management system including but not limited to a Microsoft® SQL Server. The data lake 114 stores system data prior to it being normalized 115, structured 116, and/or enriched 117. As described herein, the data in the data lake 114 may be further refined through the steps of normalization 115, structuring 116 and enrichment 117. In an embodiment, data normalization 115 may convert the values of parameters to metrics and formats defined by the system 105. Although not always the case, data normalization 115 may be necessary for the marketing module 104 to deliver relevant and personalized incentive offers 106. For example, a smart refrigerator operating in the United States may report its current operating temperature in Fahrenheit, while another smart refrigerator operating in Asia may indicate its operating temperature in Celsius. Data normalization 115 standardizes these different parameters into more uniform formats and metrics. Thus, data normalization 115 may allow the marketing module 104 to more easily map the data it receives and consequently produce tailored incentive offers 106.

In an embodiment, once the dataset is normalized 115, parameters may be formatted to indicate relationships between the datasets. Data structuring 116 structures datasets into system 105 defined datasets and assigns relationships between the data. For example, the incoming operational data 121 and usage data 122 may contain data pertaining to, but not limited to, the physical location of the smart product 101. This physical location parameter may contain data about at least one smart product's 101 city, state, country and postal code in a single string. This value may be parsed to derive individual parts of the address, i.e., an address may indicate the city, state and country of the product user 107. A detailed representation of parameters, like an address, may enhance the accuracy of the marketing module 104. By creating more precise parameters through data structuring 116, smart products 101 may be matched with available retail offers 120 based on their closest matching postal code. The parameters may also be expanded. For instance, the timestamp parameter may be manipulated to exhibit generic metrics like morning/afternoon/evening and the temperature parameter may be altered from specific temperature to indicate more general low/average/high range. This broader perspective may further assist the marketing module 104 to formulate relevant and targeted incentive offers 106 for the product user 107.

In an embodiment, usage data 122 may refer to a product user's 107 use of and/or habits associated with the smart product 101. For instance, a product user 107 may prefer to use a smart air-conditioner at lower temperatures the afternoon. The marketing module 104 may be configured to consider the average afternoon temperature in the product user's 107 location. Based on its analysis, the marketing module 104 assesses, for example, whether the window glass is laminated, and if it is not, the marketing module 104 may assist in creating an incentive offer 106 purchase of window laminates. Hence, data structuring 116 may assist the marketing module 104 in analyzing which incentive offer(s) will be of interest to a product user 107.

After the dataset is normalized 115 and structured 116, it may be enriched with additional and relevant parameters. Enrichment 117 may help the marketing module 104 create more accurate incentive offers 106. In data enrichment 117, the operational data 121 and the usage data 122 that a smart product 101 transmits may be supplemented with additional information. The additional information may pertain to the smart product 101 being analyzed by the system 105, and may assist the marketing module 104 in delivering a more targeted and personalized incentive offer 106 to the product user 107. For instance, during data enrichment 117, information about the specific conditions of a smart product 101 and/or the smart product's 101 environment may be added to the dataset. This specific information may assist the marketing module 104 in gaining further details about the smart product's 101 working environment, including but not limited to, external factors and the current condition of the smart product 101 and its parts. Data enrichment 117 parameters may also indicate the product user's 107 usage. Once these operating conditions and behavior patterns are established, the marketing module 104 may deliver relevant and personalized incentive offers 106 to the product user 107.

As an example of how data enrichment 117 assists the marketing module 104 in creating more precise incentive offers 106, a product user 107 may prefer to operate a smart air-conditioner at low temperatures. In an incoming dataset, the current operating temperature may be available, but the outdoor temperature may not be available. To best understand the operating conditions of the smart air-conditioner, the marketing module 104 may require a relative difference of temperatures. During data enrichment 117, such relevant parameters may be added to the dataset For example, data enrichment 117 may provide the outside temperature to the marketing module 104. If the relative difference in inside versus outside temperature is high, the marketing module 104 may create an incentive offer 106 for window laminates and/or insulation. Conversely, if the difference between inside and outside temperature is low or negligible, the marketing module 104 may recommend filter replacement. Thus, data enrichment 117 helps the system 105 create targeted incentive offers 106.

Further, in another embodiment, data enrichment 117 may be useful to indicate the past behavior of a product user 107 in the available dataset. The past behavior may be reflected in the smart product's 101 usage data 122, which may indicate the type of incentive offers 106 the product user 107 has accepted, or it may indicate the product user's 107 usage behavior with other smart products 101. This additional information may be analyzed by the marketing module 104 to deliver targeted incentive offers 106. For example, if a product user 107 consistently accepts incentive offers 106 involving part replacements, the marketing module 104 takes this information into account. The marketing module 104 uses this information to give more weight to an incentive offer 106 for part replacement and less weight an incentive offer 106 that offers product replacement.

The marketing module 104 may be configured to analyze previous decisions by the product user 107 by assigning a percentage on each decision made by product user 107. If a product user 107 previously accepts an incentive offer 106, the acceptance decision may be recorded in the user profile and a percentage is assigned to it. If a product user 107 accepts the first incentive offer 106, the acceptance percentage assigned is 100%. If the same product user 107 rejects the next incentive offer 106 that rejection decision is recorded; the acceptance percentage is adjusted to 50% and the rejection percentage is set to 50%. Acceptance and rejection rates and percentages are an example of the data attributes added to the operational data 121 and usage data 122 during the process of data enrichment 117. For example, when the system 105 evaluates whether to offer a part replacement, the marketing module 104 may be configured to analyze the percentage of time that a product user 107 accepted past part replacement incentive offers 106. If it is a favorable percentage, for instance over 50%, the marketing module 104 may generate an incentive offer 106 comprising a part replacement. By utilizing historical data about whether a product user 107 accepts or rejects an incentive offer, the marketing module 104 may generate an incentive offer that comports with the product user's 107 behavioral patterns. User profile data including, but not limited to, acceptance or rejection percentage may be stored in the data warehouse 118.

Once clean data is normalized 115, structured 116, and enriched 117, it is ready to be stored in the data warehouse 118. The data warehouse 118 is the system's 105 memory bank data may be stored in the data warehouse 118 and remain accessible by the system 105 for future use. Data in the data warehouse 118 may be processed by the marketing module 104 as illustrated in FIG. 4. The memory of the data warehouse can be any type of memory known to those skilled in the art.

FIG. 4 illustrates an embodiment of the marketing module 104. Modules may comprise either software modules (e.g., code embodied (1) on a non-transitory machine-readable medium, or (2) in a transmission signal) or hardware-implemented modules. The marketing module 104 is a component capable of processing a particular set of algorithms. The set of algorithms may include, but is not limited to, at least one machine learning algorithm to determine a smart product 101 user's usage patterns 123. These algorithms may examine the strength and direction of the relationship between operational data 121 and usage data 122 with the use of statistical methods to determine usage patterns 123 of a product user 107, in order to make at least one targeted and personalized incentive offer 106. In an embodiment, the usage patterns 123 may refer to a relationship between a smart product's 101 usage data 122 and its operational data 121. These trends may be determined by an algorithm that performs correlation analysis on measurable and continuous operational data 121 and usage data 122 received from the manufacturer. Correlation analysis may be used to calculate a correlation coefficient and may determine the strength of the relationship between operational data 121 and usage data 122 in order to establish usage patterns 123. Though correlation analysis is mentioned here, other appropriate steps and/or methods may also be used. Usage patterns 123 may correspond to at least one of the following: smart product 101 settings that are used frequently; times of day in which the settings are used; days of a week in which the settings are used; a frequency in which the settings arc used; and duration of time in which the settings are used.

Additionally, usage patterns 123 may indicate the behavioral patterns of the product user 107. In an embodiment, the behavioral patterns of a product user 107 are predicted by an algorithm that performs logistic regression analysis on operational data 121 and usage data 122. Consequently, the usage patterns 123 may predict a product user's 107 preferences based on his or her behavioral patterns and help the system 105 tailor incentive offers 106 accordingly. For example, a marketing module's 104 algorithm may analyze a user's 107 usage pattern 123 and identify that the user 107 does not use a smart product 101 in the manner specified by the manufacturer. This analysis may then be used to help create an incentive offer 106 for a new smart product 101 with specifications that align more closely with the user's 107 usage patterns 121 Furthermore, the marketing module 104 may utilize an algorithm configured to analyze a user's 107 decision making history in response to incentive offers 106. This decision making history may comprise the rejection and acceptance percentage data, described above, as calculated during data enrichment 117. The algorithm may utilize the acceptance and rejection percentages to create improved incentive offers 106. For instance, the system 105 will avoid making incentive offers 106 with a historical rejection percentage above 50%. Thus, the marketing module 104 may be configured to create increasingly targeted and personalized incentive offers 106 to a particular product user 107.

FIG. 4 also illustrates that the data warehouse 118 may be configured to store the cleaned and processed (i.e., normalized, structured and enriched) data associated with at least one smart product 101. This cleaned and processed data may convey information including, but not limited to, the current operational and usage data of the smart product or products 101. The data warehouse 118 also may be configured to store data about the product user 107. This data may be stored in a product user 107 profile, which may describe the product user 107 including, but not limited to, the product user's usage patterns 123. The marketing module 104 may be configured to assess the data in the data warehouse 118 and may analyze data including, but not limited to, a product user's 107 usage patterns 123.

The marketing module 104 then may generate at least one incentive offer 106 by matching the product user's 107 operational data 121, usage data 122 or usage patterns 123 with available retail offers (“ROs”) 120. ROs 120 are offers from retailers who have elected to participate in the SDPS program. These ROs 120 are stored in a database management system. The matching process performed by the marketing module 104 may involve a cross reference table to sort and match the data. In one embodiment, the operating data 121 of a particular smart refrigerator, for example “brand x, model 1”, may indicate that the refrigerator's filter needs to be replaced. The marketing module 104 may receive this data, analyze it, and then query all available ROs 120 to sec if there is a matching retail offer 120 involving a filter replacement for that same brand and model. In another embodiment, usage data 122 may indicate that a specific smart washing machine, “brand y, model 2” is being used by a product user 107 at a greater than average frequency; therefore, the washing machine needs maintenance earlier than typically scheduled. The marketing module 104 then queries all available ROs 120, to see if there is any matching retail offer involving smart washing machine maintenance of the same brand and model. In another embodiment, usage patterns 123 may indicate that a product user 107 consistently lowers the temperature on his or her thermostat in the afternoon. This usage pattern 123 may reflect that the product user 107 has potential home insulation problems or needs. Consequently, the marketing module 104 may query all available ROs 120 to see if there is any matching retail offer involving home insulation products. In at least one embodiment, once the matching process is completed and there is at least one RO 120 that has been matched with a product user 107, the marketing module 104 may generate an incentive offer comprising the matched RO 120 and transmit it to the control center 110.

Additionally, the embodiment shown in FIG. 4 may include a data analytics 119 step. The data analytics 119 step may be carried out by an external data analyst or may be performed internally, depending on the desired system configuration. For example, in data analytics 119, a data analyst may examine data taken from the data warehouse 118, or assesses the performance of the marketing module's 104 machine learning algorithms. Furthermore, the data analyst may help identify inefficiencies and find ways to improve the marketing module's 104 machine learning algorithms.

While the best mode for carrying out the preferred embodiment of the invention has been illustrated and described in detail, those skilled in the art to which the invention pertains recognize that various alternative designs and embodiments other than those claimed below may fall within the scope and spirit of the disclosed invention.

1. A computerized system for marketing incentive offers, comprising:
a smart product enabled to receive and transmit data over the internet;
said smart product including a gateway for receiving data generated from said smart product and forwarding said data to a marketing module;
said marketing module normalizing said data to account for data received from different manufacturers, structuring said data to organize said data into predefined data sets, and enriching said data using parameters unique to a particular user of said smart product;
said marketing module including a control center that receives said data processed by said marketing module and formulates an incentive offer based on predefined rules and the smart product user's prior actions and prior preferences; and
transmitting said incentive offer to the user of said smart product.

2. The system recited in claim 1, wherein:
said smart product is one of a smart television, smart refrigerator or smart air conditioner.

3. The system recited in claim 1, wherein:
said data received from said manufacturer comprises details of said smart product and said smart product's current operational status.

4. The system recited in claim 1, wherein:
prior to transmitting said data to said marketing module, said data is cleaned by removing data unrelated to predefined parameters of a search entered by a user of said smart product.

5. The system recited in claim 1, wherein:
said data structuring comprises organizing said data into subgroups.

6. The system recited in claim 1, wherein:
evaluating said data comprises considering a smart product user's preferences and past activities.

7. The system recited in claim 1, wherein:
a user of said smart product interacts directly with said manufacture through a voice assistant service; and
said voice assistant service being integral with said smart product and capable of receiving commands from said user and transmitting requests based thereon to said marketing module.

8. The system recited in claim 1, wherein:
said system comprises a data warehouse, said data warehouse comprises memory configured to store at least operational data and usage data, said stored operational data and usage data is executable by said marketing module, to perform at least: cross-referencing said stored data with at least one retail offer.

9. The system recited in claim 1, wherein:
said system comprises a data lake, said data lake comprises memory configured to store at least cleaned data, said cleaned data is executable by said marketing module, to perform at least said data normalization.

10. The system recited in claim 1, wherein:
said system comprises a data analytics step wherein at least one data analyst performs one or more tasks, including assessing said smart product's operational data and transmitting said assessment to said marketing module.

11. The system recited in claim 1, wherein:
said system comprises at least one retail offer, said retail offer being processed by the marketing module, said processing comprises at least cross-referencing said retail offer with said smart product data.

12. The system recited in claim 7, wherein:
said incentive offer is transmitted to said manufacturer's voice assistant service prior to transmission to said user, said manufacturer's voice assistant converts speech to text, processes said request, and transmits an incentive offer to said user using a verbal voice command.

13. A computerized system for marketing incentive offers, comprising:
a memory;
one or more processors; and
one or more components comprising: at least one gateway, at least one marketing module, at least one control center, at least one interface, at least one voice assistant service, at least one data warehouse, and at least one data lake, executed on the one or more processors to:
i. obtain, from one or more of the smart products, usage data associated with one or more product users associated with the smart product;
ii. determine usage patterns associated with the smart product based at least in part on the obtained operational data and the usage data;
iii. cross-reference at least one of the operational data, the usage data or the usage patterns, with at least one retail offer; and
iv. create at least one incentive offer based at least in part on the operational data, usage data and retail offers; and
v. transmit said at least one incentive offer to a product user or a smart product.

14. The system as recited in claim 13, wherein said usage data and said operational data are utilized to establish current or past usage patterns of at least one product user.

15. The system as recited in claim 13, wherein said smart product is associated with said product user based at least partly on a determination that the usage patterns associated with said smart product meet a threshold associated with said product user.

16. The system as recited in claim 13, wherein said one or more components are executed on said one or more processors to identify events or details that correspond to at least one of said usage data and said operational data; determine said product user's patterns and preferences based at least in part on said details and events; and associate said details with at least one of said product user and said smart product based on usage patterns of at least said product user and said smart product.

17. The system as recited in claim 13, wherein said usage patterns correspond to at least one of smart product settings that are used frequently, times of day in which the settings are used, days of a week in which the settings are used, a frequency in which the settings are used, or a duration of time in which the settings are used.

18. The system as recited in claim 13, wherein said at least one incentive offer is based at least in part on said product user's usage patterns, operational data, and usage data.

19. The system as recited in claim 13, wherein said at least one incentive offer incorporates at least one of a retail offer or a usage pattern.

20. The system as recited in claim 13, wherein said at least one incentive offer includes information that is targeted to one or more smart product users, the information comprising at least one gift card, gift code, sale, advertisement, service, or part replacement offer that is associated with at least one of said smart product users and at least one of said smart products.

21. The system as recited in claim 13, wherein said one or more steps are executed on said one or more processors to clean operational and usage data, including raw data associated with at least one smart product, normalize said operational and usage data associated with the at least one smart product, stricture said operational and usage data associated with said at least one smart product, and enrich said operational and usage data associated with said at least one smart product.

22. The system as recited in claim 13, wherein said one or more components maintained in the memory and executed on said the processor comprise: at least one gateway configured to receive and transmit data; at least one marketing module configured to receive, process and transmit data; at least one data warehouse configured to at least receive and store data; at least one data lake configured to at least receive and store data; at least one control center configured to at least receive and transmit data; at least one interface configured to receive and transmit data; and at least one voice assistant service configured to receive and transmit data.

23. A method for marketing incentive offers via the internet, comprising the steps of:
obtaining data that corresponds to one or more smart products associated with a product user;
obtaining from said one or more smart products operational data and usage data associated with said product user;
obtaining a retail offer from one or more retailers;
determining usage patterns of said smart product based at least in part on the operational data or usage data;
associating at least one product user with said one or more smart products based in part on a determination that at least one usage pattern relates to said at least one product user;
matching retail offers with said usage patterns associated with said product user; and
providing one or more incentive offers to said smart product, said one or more incentive offers comprising information about said retail offer associated with said usage patterns of said product user.

24. The method as recited in claim 23 wherein, said usage patterns represent one or more categories of behavior exhibited by said at least one product user.

25. The method as recited in claim 23 wherein,
said one or more incentive offers are targeted towards said at least one product user such that at least one product user associated with said smart product receives said incentive offers, and said incentive offers are determined to be relevant to said product user.

26. The method as recited in claim 23 wherein, said incentive offers are further based on data regarding said product user's acceptance or rejection of past incentive offers, and said incentive offers being based on said product user's usage patterns associated with said smart product.

27. The method as recited in claim 23 wherein said product user is associated with said smart product based at least in part on a similarity between said usage patterns associated with said smart product and usage behavior associated with said at least one product user satisfying a predetermined threshold.

28. The method as recited in claim 23, further comprising cleaning operational and usage data, including any raw data, associated with at least one smart product; normalizing the operational and usage data associated with said smart product; structuring said operational and usage data associated with the said smart product; and enriching said operational and usage data associated with said at least one smart product.

29. The method as recited in claim 28, further comprising analyzing raw data and processed data utilizing data analytics to refine said at least one incentive offer.

30. One or more computer-readable media having computer executable instructions that, when executed by one or more processors, cause the one or more processors to perform operations comprising:
obtaining data that corresponds to one or more smart products associated with a product user;
obtaining from said one or more smart products operational data and usage data associated with said product user;
obtaining retail offers from one or more retailers;
determining usage patterns of said smart product based at least in part on said operational data or usage data;
associating at least one product user with said one or more smart products based in part on a determination that at least one usage pattern relates to said at least one product user;
matching retail offers with said usage patterns associated with said product user; and
providing one or more incentive offers to said smart product, the incentive offers comprising information about said retail offer associated with said usage patterns of said product user.

31. The one or more computer-readable media as recited in claim 30, wherein said one or more incentive offers include information that is targeted to one or more smart product users; and said targeted information comprises at least one gift card, gift code, sale, advertisement, service, or part replacement offer that is associated with at least one of said product users or at least one of said smart products.
